(19) United States
(12) Patent Application Publication
(10) Pub. No.: US 2025/0279617 A1
(43) Pub. Date: Sep. 4, 2025

(54) CONNECTOR

(71) Applicant: Yazaki Corporation, Tokyo (JP)

(72) Inventors: Hideki SAITO, Shizuoka (JP); Takuya HASEGAWA, Shizuoka (JP); Kazuya TERAO, Shizuoka (JP)

(73) Assignee: Yazaki Corporation, Tokyo (JP)

(21) Appl. No.: 19/042,236

(22) Filed: Jan. 31, 2025

(30) Foreign Application Priority Data
Mar. 4, 2024 (JP) 2024-031917

(51) Int. Cl. H01R 13/639; H01R 13/627; H01R 13/629

(52) U.S. Cl. CPC H01R 13/639; H01R 13/629; H01R 13/6272

(57) ABSTRACT

A connector includes: a housing configured to be connectable to a mating connector and forming an assembly space along a connecting direction; and a position assurance member inserted into the assembly space and assembled with respect to the housing to be movable from a temporary locking position to a main locking position along the connecting direction, in which the assembly space is formed between two side walls formed in the housing and extending in the connecting direction.

### CROSS-REFERENCE TO RELATED APPLICATION(S)

The present application claims priority to and incorporates by reference the entire contents of Japanese Patent Application No. 2024-031917 filed in Japan on Mar. 4, 2024.

### BACKGROUND OF THE INVENTION

### 1. Field of the Invention

The present invention relates to a connector.

### 2. Description of the Related Art

Conventionally, as a connector, for example, as described in Japanese Patent Application Laid-open No. 2017-157454, a connector connected to a mating connector and having a connector position assurance function is known. This connector includes a position assurance member that assures a fitting state with the mating connector. The position assurance member is attached to a housing of the connector and is disposed at a standby position. After the connector and the mating connector are fitted to each other, the position assurance member is moved in the fitting direction, and is moved from the standby position to the fitting lock position. When the position assurance member can move to the fitting lock position, it is assured that the connector and the mating connector are appropriately fitted with each other.

In the connector described above, there is a portion where the housing and the position assurance member engage, and the mechanical strength of the engaging portion may be lower than that of other portions. Therefore, it is desired to develop a connector capable of improving strength.

### SUMMARY OF THE INVENTION

Therefore, an object of the present invention is to provide a connector capable of improving strength.

A connector according to one aspect of the invention includes a housing configured to be connectable to a mating connector and forming an assembly space along a connecting direction; and a position assurance member inserted into the assembly space and assembled with respect to the housing to be movable from a temporary locking position to a main locking position along the connecting direction, wherein the assembly space is formed between two side walls formed in the housing and extending in the connecting direction, the housing includes a locking member that engages with the position assurance member assembled in the assembly space and locks the position assurance member at the main locking position, the locking member includes an installation portion installed between the two side walls and provided on a side of a fitting surface facing the mating connector, and the installation portion forms a recess in which a surface facing the mating connector is depressed along the connecting direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a connector according to an embodiment;

FIG. 2 is a perspective view of the connector according to the embodiment;

FIG. 3 is a plan view of the connector according to the embodiment in an exploded state;

FIG. 4 is a perspective view of a housing in the connector according to the embodiment;

FIG. 5 is an explanatory view of a main locking state of a position assurance member in the connector according to the embodiment;

FIG. 6 is an explanatory view of connection in the connector according to the embodiment; and

FIG. 7 is an explanatory view of mechanical strength in the connector according to the embodiment.

### DETAILED DESCRIPTION OF THE PREFERRED EMBODIMENT

Hereinafter, an embodiment according to the present invention will be described in detail with reference to the drawings. Note that the present invention is not limited by the embodiment. In addition, constituent elements in the following embodiments include those that can be easily replaced by those skilled in the art or those that are substantially the same.

### Embodiment

The present embodiment relates to a connector. In the following description, among a first direction, a second direction, and a third direction intersecting each other, the first direction is referred to as a “connecting direction X”, the second direction is referred to as a “width direction Y”, and the third direction is referred to as a “height direction Z”. Here, the connecting direction X, the width direction Y, and the height direction Z are orthogonal to each other. The connecting direction X corresponds to a connecting direction or a fitting direction of a connector and a mating connector. The width direction Y corresponds to the width direction of the connector. The width direction Y and the height direction Z correspond to an orthogonal direction orthogonal to the connecting direction X. In addition, each direction used in the following description represents a direction in a state in which each part is assembled to each other unless otherwise specified. Note that the term “orthogonal” as used herein includes substantially orthogonal.

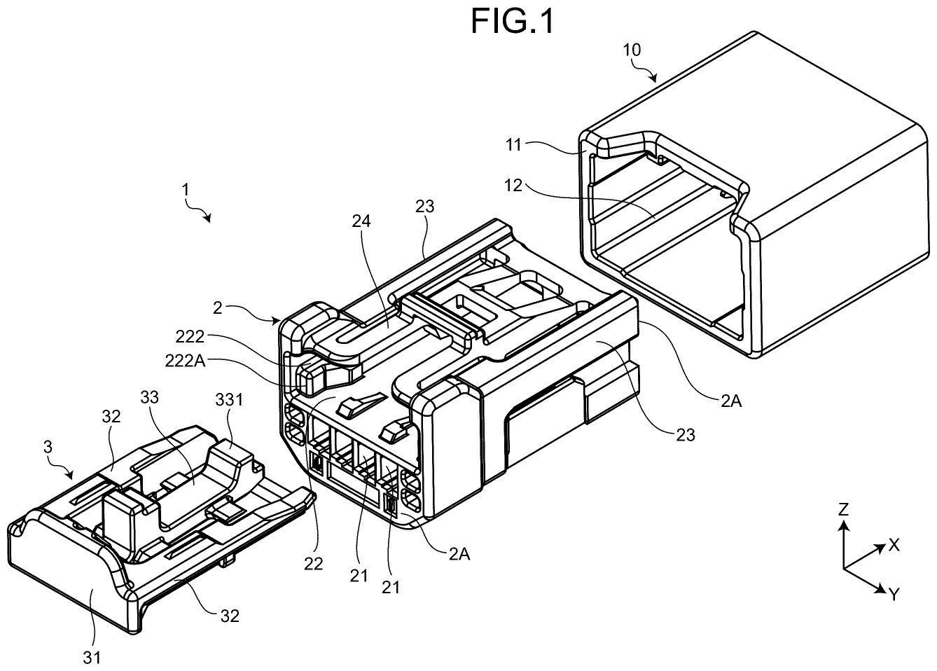

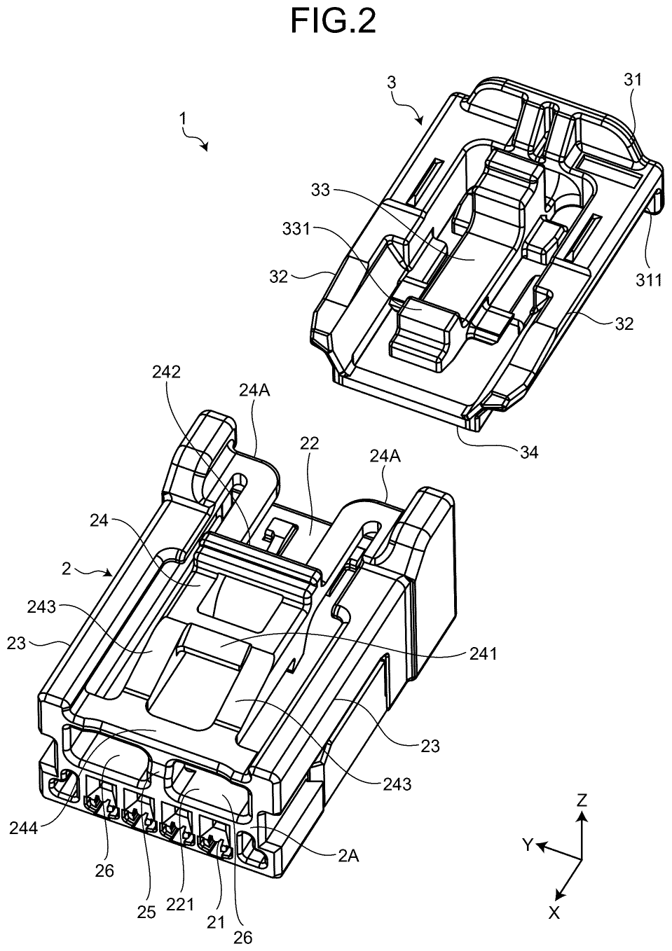

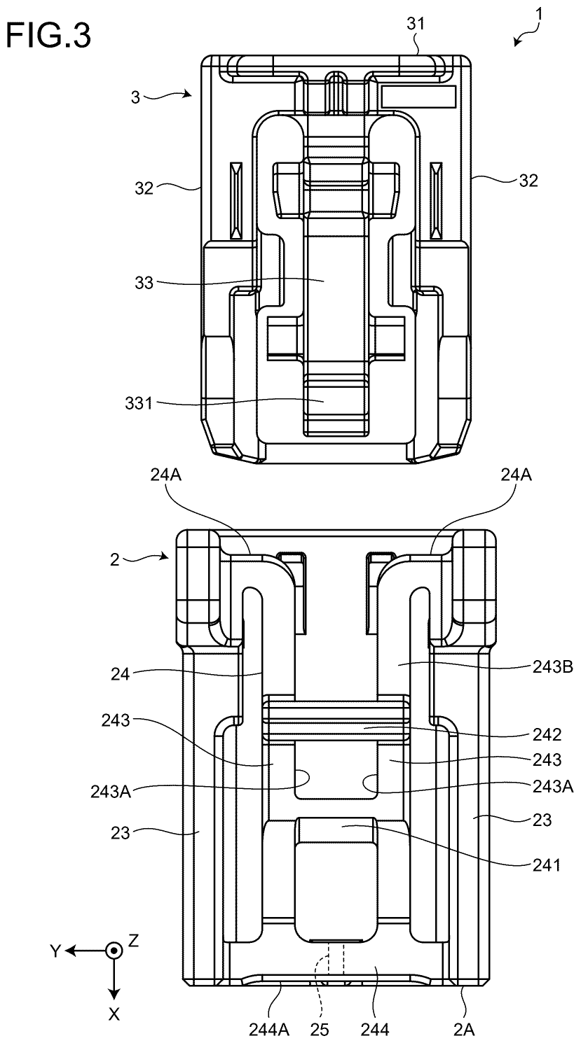

As illustrated in FIGS. 1 to 3, a connector 1 according to the present embodiment is a connector used by being connected to a mating connector 10, and has a connector position assurance (CPA) function. The connector 1 includes a housing 2 and a position assurance member 3. FIG. 1 illustrates a state in which the connector 1 and the mating connector 10 are spaced apart from each other and the housing 2 and the position assurance member 3 are separated from each other. The housing 2 is a member to be fitted to the mating connector 10, and is formed in, for example, a block shape. The housing 2 is made of resin, for example, and is formed by resin molding. The housing 2 forms an installation hole 21 for disposing a terminal. The installation hole 21 is formed along the connecting direction X with the mating connector 10. A plurality of installation holes 21 are formed, and for example, a plurality of installation holes are arrayed in the width direction Y. The installation hole 21 is formed to penetrate the housing 2 in the connecting direction X, and inserts and holds a terminal of a terminal-equipped electric wire (not illustrated).

In the housing 2, an assembly space 22 is formed above a region where the installation hole 21 is formed. The assembly space 22 is a space for inserting and assembling the position assurance member 3, and is formed, for example, between two side walls 23 provided spaced apart from each other in the width direction Y of the housing 2. The side wall 23 is a wall body provided at each end portion in the width direction Y of the housing 2 and extending in the height direction Z and the connecting direction X. That is, the two side walls 23 partition side portions on both sides of the assembly space 22 to define the assembly space 22.

A guide portion 222 is formed in the assembly space 22. The guide portion 222 is formed along the connecting direction X at a position of a lower end portion of the assembly space 22. For example, the guide portion 222 is formed to project out in the width direction Y from the inner surface of the side wall 23. The guide portion 222 guides the position assurance member 3 along the connecting direction X at the time of assembly of the position assurance member 3. Furthermore, the guide portion 222 functions as a stopper at the time of assembly of the position assurance member 3. For example, an end face 222A on a side opposite to a fitting surface 2A of the guide portion 222 abuts on the position assurance member 3 at the time of assembly of the position assurance member 3, and arranges the position assurance member 3 at the main locking position. The fitting surface 2A is an end face of the housing 2 in the connecting direction X, and is a surface facing the mating connector 10 in a state where the housing 2 is fitted to the mating connector 10.

The housing 2 is provided with a locking member 24. The locking member 24 is a member that locks the housing 2 with respect to the mating connector 10 at the time of connection of the connector 1 and the mating connector 10, and is a member that engages with the position assurance member 3. The locking member 24 is provided, for example, in the assembly space 22 and is installed along the connecting direction X.

The locking member 24 includes a locked portion 241, a pressing portion 242, an arm portion 243, and an installation portion 244. The locked portion 241 is a site that engages with the locking portion 121 of the mating connector 10 and the locking portion 331 of the position assurance member 3. The pressing portion 242 is a site that releases the engagement between the locked portion 241 and the locking portion 121 by being pressed and releases the locked state of the mating connector 10 and the housing 2. Each of the locked portion 241, the pressing portion 242, and the installation portion 244 extends in the width direction Y intersecting the connecting direction X, and is connected to, for example, two arm portions 243. The two arm portions 243 are disposed spaced apart from each other in the width direction Y and extend in the connecting direction X. The locked portion 241, the pressing portion 242, and the installation portion 244 are installed between the two arm portions 243, and the installation portion 244, the locked portion 241, and the pressing portion 242 are arranged in this order from the fitting surface 2A side.

The locked portion 241 is provided, for example, between the opposing surfaces 243A of the two arm portions 243. The pressing portion 242 is provided so as to project out upward in the height direction Z as compared with the locked portion 241, and is connected to, for example, upper surfaces 243B of the two arm portions 243. The installation portion 244 is connected to end portions on the fitting surface 2A side of the two arm portions 243. The installation portion 244 is formed to be longer than the distance between the two arm portions 243, and the end portions on both sides are respectively connected to the side walls 23. A column portion 25 is connected to a central position of the installation portion 244 in the width direction Y. The column portion 25 is a member extending along the height direction Z, and is provided between the installation portion 244 and a floor portion 221 of the assembly space 22. The column portion 25 supports the installation portion 244 from below. That is, the locking member 24 is supported at three points on the fitting surface 2A side, and the strength is increased.

That is, the locking member 24 is supported by the two side walls 23 and the column portion 25 through the installation portion 244 on the fitting surface 2A side, and has a structure that is hardly damaged even when receiving an external force. For example, if the installation portion 244 is supported at two points by the two side walls 23, the installation portion 244 has a structure that is easily bent in the height direction Z, and the strength against the external force decreases. On the other hand, in the connector 1 according to the present embodiment, since the locking member 24 is supported at three points, strength can be improved, and strength against the external force can be enhanced.

The end portions on the side opposite to the fitting surface 2A of the two arm portions 243 are connected to the side walls 23, respectively. That is, the locking member 24 is supported on each of the fitting surface 2A side and both sides opposite to the fitting surface 2A. Therefore, the strength of the locking member 24 is improved as compared with the case of the cantilever structure.

A recess 244A is formed in the installation portion 244. The recess 244A is formed by depressing a surface facing the mating connector 10 in the installation portion 244 along the connecting direction X. For example, the recess 244A is formed by depressing the entire installation portion 244 in the connecting direction X. Here, the whole includes substantially the whole. The installation portion 244 of the locking member 24 has a structure that is less likely to receive an external force due to the formation of the recess 244A. For example, even when the connector 1 falls on the floor, the installation portion 244 is less likely to directly come into abutment with the floor surface, and the locking member 24 is less likely to receive an impact.

As illustrated in FIGS. 1 to 3, the position assurance member 3 is configured such that the guide arm 32 and the locking arm 33 project out from a base portion 31 in the connecting direction X. The base portion 31 is a plate-like site raised upward, and is provided in a direction intersecting the connecting direction X. Two guide arms 32 are provided, and extend in the connecting direction X from both end portions in the width direction Y of the base portion 31. When the position assurance member 3 is assembled to the assembly space 22 of the housing 2, the guide arm 32 is inserted along the guide portion 222.

The locking arm 33 is provided to project out in the connecting direction X between the two guide arms 32. The locking arm 33 is an engagement portion that engages with the housing 2. When the position assurance member 3 is assembled to the assembly space 22, the locking arm 33 is inserted between the two arm portions 243. The locking arm 33 is formed with a locking portion 331. The locking portion 331 is a site that engages with the locked portion 241 of the locking member 24 of the housing 2. When the position assurance member 3 is inserted with respect to the housing 2 up to the temporary locking position (standby position), the locking portion 331 is disposed at a position in front of the locked portion 241. When the connector 1 is appropriately connected to the mating connector 10, the position assurance member 3 can be inserted with respect to the housing 2 up to the main locking position, and it can be recognized that the connector 1 is appropriately connected to the mating connector 10. At this time, due to the insertion of the position assurance member 3, the locking portion 331 can move toward the fitting surface 2A side of the housing 2 with respect to the locked portion 241 by going under the locked portion 241. On the other hand, when the connector 1 is not appropriately connected to the mating connector 10, the position assurance member 3 cannot be inserted with respect to the housing 2 up to the main locking position. That is, the locking portion 331 cannot move to the fitting surface 2A side of the locked portion 241 by going under the locked portion 241.

As illustrated in FIG. 1, the mating connector 10 has a tubular shape, and is configured to allow the connector 1 to be inserted into the internal space 12 with the opposing surface 11 opened. A locking portion (not illustrated) is formed on the ceiling surface of the internal space 12. The locking portion is a protruding portion that engages with the locked portion 241 of the locking member 24. Since the locked portion 241 is locked to the locking portion, the connector 1 is suppressed from being detached from the mating connector 10. A plurality of terminals (not illustrated) are provided in the internal space 12.

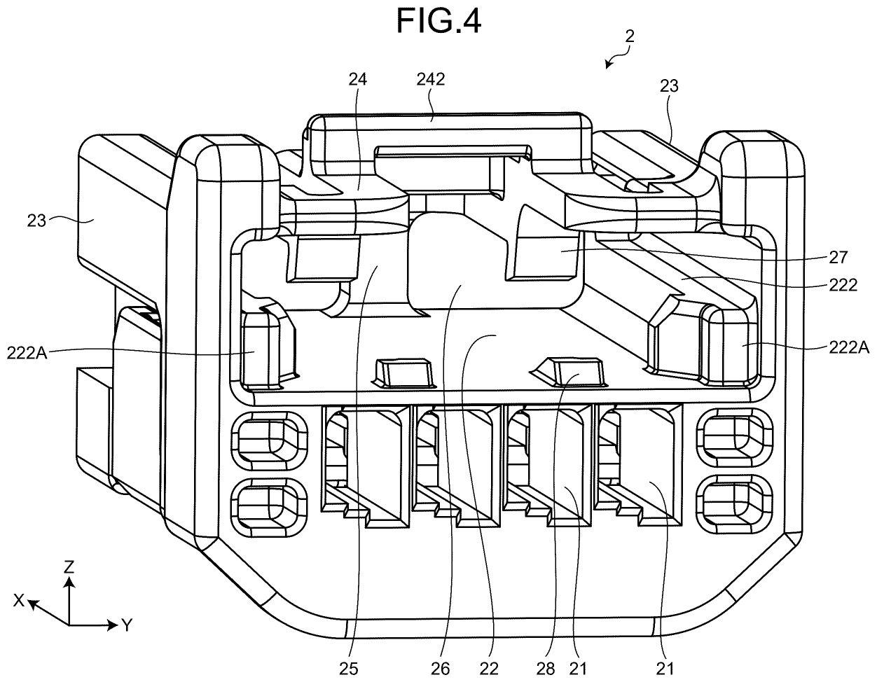

As illustrated in FIG. 4, the locking member 24 of the housing 2 forms a projection 27 projecting downward from the arm portion 243. In addition, a protrusion 28 projecting out from the floor portion 221 of the assembly space 22 is formed. Each of the projection 27 and the protrusion 28 is a site that engages with the position assurance member 3. When the housing 2 is resin molded, the connecting direction X is the direction of mold opening. In this case, when attempting to form the projection 27 and the protrusion 28, it is necessary to form the hole 26 on the fitting surface 2A side of the assembly space 22 in order to remove the mold. Although it is conceivable to open the entire portion on the fitting surface 2A side between the locking member 24 and the floor portion 221, there is a concern that the supporting strength of the locking member 24 may reduce. Therefore, in the connector 1 according to the present embodiment, the supporting strength of the locking member 24 is increased by providing the column portion 25 to support the locking member 24.

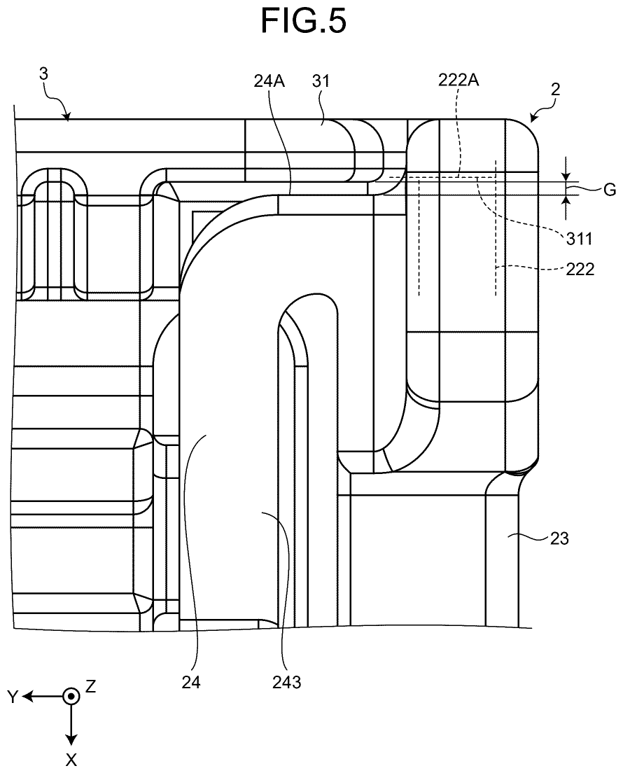

As illustrated in FIG. 5, the position assurance member 3 is assembled to the housing 2 and disposed at the main locking position. At this time, the position assurance member 3 is spaced apart from the locking member 24 and is abutted with the end face 222A of the guide portion 222. That is, the position assurance member 3 is inserted from the temporary locking position to the main locking position in the assembly space 22, but the abutment surface 311 of the base portion 31 abuts on the guide portion 222 and is disposed at the main locking position. At this time, the position assurance member 3 is spaced apart from the locking member 24, and a gap G is formed between the position assurance member 3 and the locking member 24.

Next, mechanical strength of the connector 1 according to the present embodiment will be described.

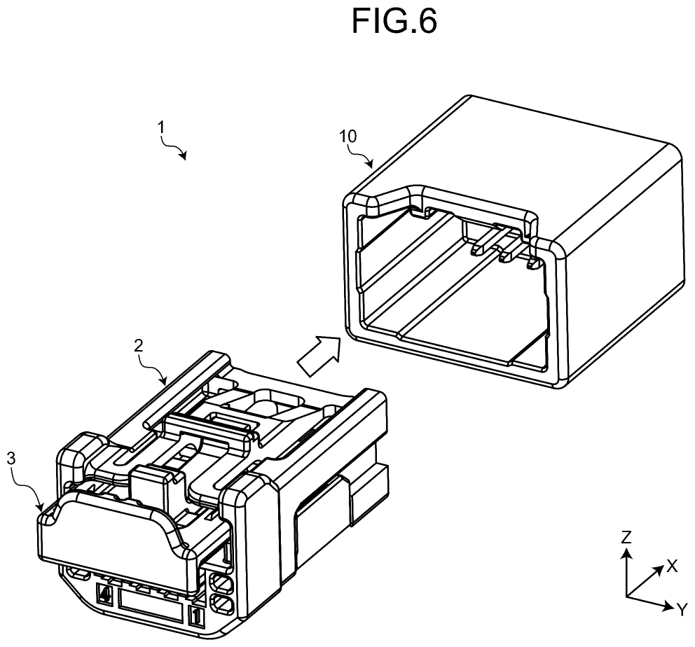

As illustrated in FIG. 6, the connector 1 is connected to the mating connector 10 by assembling the position assurance member 3 with respect to the housing 2. The position assurance member 3 is inserted with respect to the housing 2 up to the temporary locking position. An electric wire (not illustrated) is connected to the connector 1 and the mating connector 10.

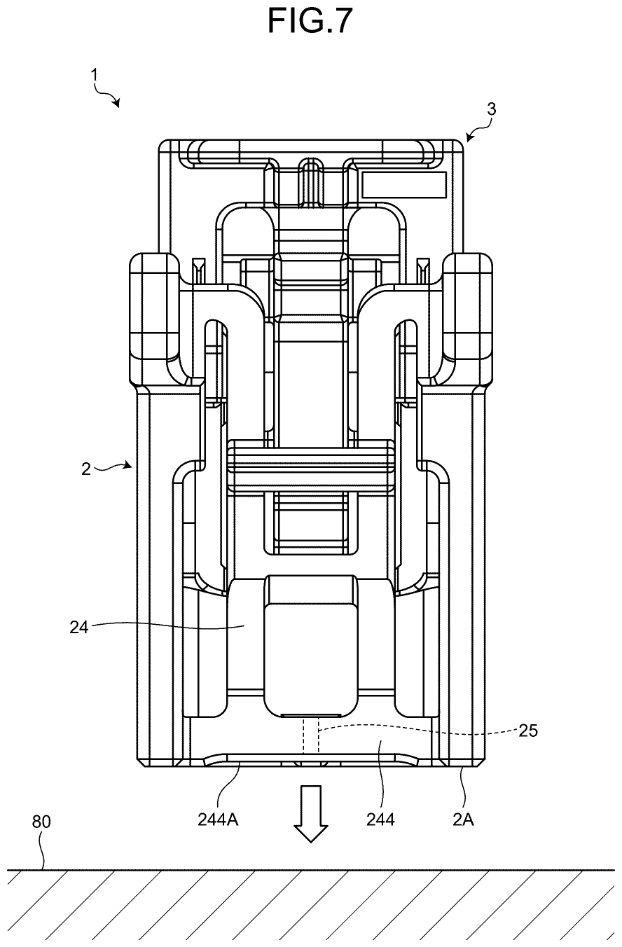

At this time, as illustrated in FIG. 7, the connector 1 may hit an external object. For example, it is conceivable that the connector 1 accidentally falls and collides with the floor surface 80. When the connector 1 falls with the fitting surface 2A facing downward, the fitting surface 2A collides with the floor surface 80. In this case, the connector 1 receives an impact from the fall, but application of a large impact to the locking member 24 is suppressed. That is, the recess 244A is formed in the installation portion 244 of the locking member 24, and the locking member 24 is provided to be recessed from the fitting surface 2A. Therefore, in the connector 1 according to the present embodiment, the locking member 24 is suppressed from directly abutting on the floor surface 80, and the impact received from the floor surface 80 can be reduced.

In addition, the locking member 24 is supported at three points in the housing 2, and the mechanical strength is improved. That is, the installation portion 244 of the locking member 24 is connected to the side walls 23 on both sides and is connected to the column portion 25 extending from the floor portion 221 of the assembly space 22. Therefore, the installation portion 244 has a structure that is less likely to move in the width direction Y and the height direction Z, and has a structure that is less likely to deform when receiving an impact. Therefore, in the connector 1 according to the present embodiment, the locking member 24 is suppressed from being easily damaged even when receiving an impact from the floor surface 80.

Furthermore, as illustrated in FIG. 5, in the connector 1, when the position assurance member 3 is assembled to the housing 2 and disposed at the main locking position, the position assurance member 3 abuts on the guide portion 222 of the assembly space 22. At this time, a gap G is formed between the position assurance member 3 and the locking member 24, and the position assurance member 3 is spaced apart from the locking member 24. Therefore, even when the connector 1 comes into contact with an external object, an impact is suppressed from being directly applied to the locking member 24. That is, even when the position assurance member 3 of the connector 1 comes into contact with an external object, an impact is transmitted to the guide portion 222 of the housing 2, and the impact is less likely to be transmitted to the locking member 24. In the connector according to the present embodiment, an external force is suppressed from being applied from the locking member 24, and proof stress against the external force can be improved.

As described above, the connector 1 according to the present embodiment can suppress an external force from directly applying to the locking member 24 by forming the recess 244A in the installation portion 244 of the locking member 24. As a result, the connector 1 according to the present embodiment can reduce the impact applied to the locking member 24.

Furthermore, in the connector 1 according to the present embodiment, the position assurance member 3 is spaced apart from the locking member 24 at the main locking position and is abutted on the guide portion 222. Therefore, when the position assurance member 3 receives an external force, the connector 1 according to the present embodiment can suppress transmission of the external force to the locking member 24 via the position assurance member 3. Therefore, the connector 1 according to the present embodiment can improve the mechanical strength.

In addition, in the connector 1 according to the present embodiment, the locking member 24 is supported at three points in the housing 2, and thus the mechanical strength of the housing 2 can be enhanced. That is, in the housing 2, the locking member 24 is supported at three points by being connected to the two side walls 23 and the column portion 25 while having a structure of being installed over the two side walls 23. Thus, the connector 1 according to the present embodiment can strongly support the locking member 24 and improve the mechanical strength.

Note that the connector according to the present invention is not limited to the above-described embodiment, and various modifications can be made within the scope described in the claims. The connector according to the present embodiment may be configured by appropriately combining the components of each embodiment and modified examples described above.

For example, in the above-described embodiment, the case has been described in which the guide portion 222 projects out from the side wall 23 in the locking member 24, but the guide portion 222 may not be provided, and the position assurance member 3 may be configured to abut on a portion other than the guide portion 222 of the housing 2. Even in this case, the strength of the connector 1 can be improved by forming the recess 244A in the installation portion 244 of the locking member 24.

According to the connector of the embodiment, strength can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing configured to be connectable to a mating connector and forming an assembly space along a connecting direction; and
a position assurance member inserted into the assembly space and assembled with respect to the housing to be movable from a temporary locking position to a main locking position along the connecting direction, wherein
the assembly space is formed between two side walls formed in the housing and extending in the connecting direction,
the housing includes a locking member that engages with the position assurance member assembled in the assembly space and locks the position assurance member at the main locking position,
the locking member includes an installation portion installed between the two side walls and provided on a side of a fitting surface facing the mating connector, and
the installation portion forms a recess in which a surface facing the mating connector is depressed along the connecting direction.

2. The connector according to claim 1, wherein
the position assurance member is, in a state of being assembled to the housing and disposed at the main locking position, spaced apart from the locking member and abutted on a guide portion formed to project out from the side wall toward a side of the assembly space.
